(19) United States
(12) Patent Application Publication
(10) Pub. No.: US 2012/0058692 A1
(43) Pub. Date: Mar. 8, 2012

(54) CONTACT OF ELECTRICAL CONNECTOR AND PLATING METHOD THEREOF

(75) Inventors: CHENG-QIANG HUANG, Dong-Guan (CN); Bing-Tao Yang, Dong-Guan (CN); Yin-Lung Wu, Tu-Cheng City (TW); Ming-Chiang Chen, Tu-Cheng City (TW)

(73) Assignee: Cheng Uei Precision Industry Co., LTD, Tu-Cheng City (TW)

(21) Appl. No.: 12/875,125

(22) Filed: Sep. 2, 2010

(51) Int. Cl. H01R 13/03; C25D 5/06; C25D 5/12

(52) U.S. Cl. 439/886; 205/181; 205/117

(57) ABSTRACT

A contact is included by an electrical connector and has a base layer and a plating layer. The base layer includes a contacting portion at one end thereof, a soldering portion at the other end thereof, and a connecting portion connecting the contacting portion and the soldering portion. The plating layer is plated on the base layer. The plating layer includes a nickel plating layer plated on the contacting portion, the soldering portion and the connecting portion of the base layer, a first gold plating layer and a second gold plating layer plated on two end portions of the nickel plating layer corresponding to the contacting portion and the soldering portion, respectively. A middle portion of the nickel plating layer corresponding to the connecting portion is exposed outside.

### BACKGROUND OF THE INVENTION

1. Field of the Invention

The present invention generally relates to an accessory of an electrical connector, and more particularly to a contact of an electrical connector and plating method thereof.

2. The Related Art

In general, a contact of an electrical connector is of a multi-layer structure. The multi-layer structure includes a base layer and a plating layer plated on the base layer. The base layer includes a contacting portion used for contacting with an electronic product, a soldering portion used for soldering to a printed circuit board and a connecting portion used for connecting with the contacting portion and the soldering portion. The base layer is generally a brass layer. The plating layer can be formed by metal (such as nickel, gold or stannum) in order to have a better electric conductive performance or a better soldering performance.

Accordingly, two conventional contact plating methods are generally described as follows. One method is to plate a nickel layer on the base layer, firstly, and then plate a gold layer on the nickel layer to improve oxidation resistance performance and electric conductive performance of the contact. Another method includes the following steps: firstly, plating a nickel layer on the base layer; secondly, plating a gold layer on a portion of the nickel layer corresponding to the contacting portion of base layer; and thirdly, plating two stannum layers on two portions of the nickel layer corresponding to the soldering portion and the connecting portion of the base layer, respectively.

The above-mentioned two methods for plating the contact can make the soldering portion have a better soldering performance and the contacting portion have a better conductive performance. But the connecting portion still has a metal layer (gold layer or stannum layer) plated on the nickel layer. So when the soldering portion of the contact is soldered to the printed circuit board, a solder climbing phenomenon of the connecting portion is apt to happen. Consequently, the electric conductive performance of the electrical connector is lowered.

### SUMMARY OF THE INVENTION

An object of the present invention is to provide a contact and a plating method thereof. The contact is included by an electrical connector and has a base layer and a plating layer. The base layer includes a contacting portion at one end thereof, a soldering portion at the other end thereof, and a connecting portion connecting the contacting portion and the soldering portion. The plating layer is plated on the base layer. The plating layer includes a nickel plating layer plated on the contacting portion, the soldering portion and the connecting portion of the base layer, a first gold plating layer and a second gold plating layer plated on two end portions of the nickel plating layer corresponding to the contacting portion and the soldering portion, respectively. A middle portion of the nickel plating layer corresponding to the connecting portion is exposed outside. The method of plating the above-mentioned contact is described hereinafter. Firstly, provide a base layer of the contact which includes a contacting portion, a soldering portion and a connecting portion connecting the contacting portion and the soldering portion. Secondly, plate a nickel plating layer on the contacting portion, the soldering portion and the connecting portion of the base layer. Thirdly, plate a first gold plating layer on a portion of the nickel plating layer corresponding to the contacting portion. Lastly, plate a second gold plating layer on a portion of the nickel plating layer corresponding to the soldering portion, with a portion of the nickel plating layer corresponding to the connecting portion exposed outside.

As described above, after the contacting portion, the soldering portion and the connecting portion of the base layer is plated by the nickel plating layer, the first and second gold plating layers are plated on the two end portions of the nickel plating layer corresponding to the contacting portion and the soldering portion, respectively, the middle portion of the nickel plating layer corresponding to the connecting portion is exposed outside to form an exposed area of nickel. So that electric conductivity performance of the contact can be guaranteed and a phenomenon of solder climbing is effectively restrained in a process of soldering the soldering portion of the contact to a printed circuit board. As a result, a better electric conductivity performance is realized.

### BRIEF DESCRIPTION OF THE DRAWINGS

The present invention will be apparent to those skilled in the art by reading the following description, with reference to the attached drawings, in which:

FIG. 1 is a perspective view of a contact of an electrical connector according to the present invention;

FIG. 2 is a front view of the contact of FIG. 1;

FIG. 3 is a sectional perspective view of a contacting portion of the contact of FIG. 2;

FIG. 4 is a sectional perspective view of a soldering portion of the contact of FIG. 2;

FIG. 5 is a sectional perspective view of a connecting portion of the contact of FIG. 2; and

FIG. 6 is a flow chart of a plating method of the invention.

### DETAILED DESCRIPTION OF THE EMBODIMENT

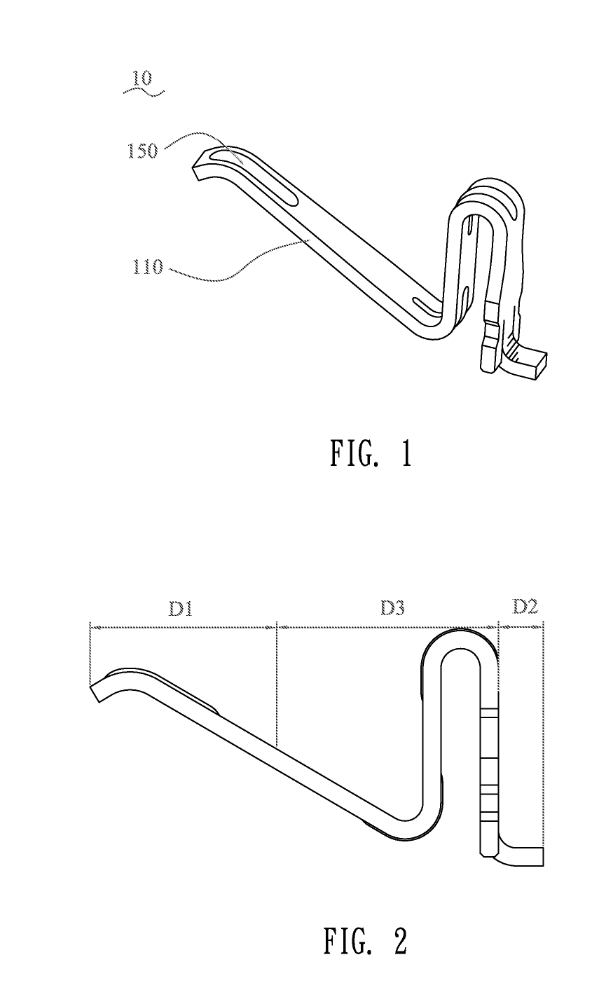

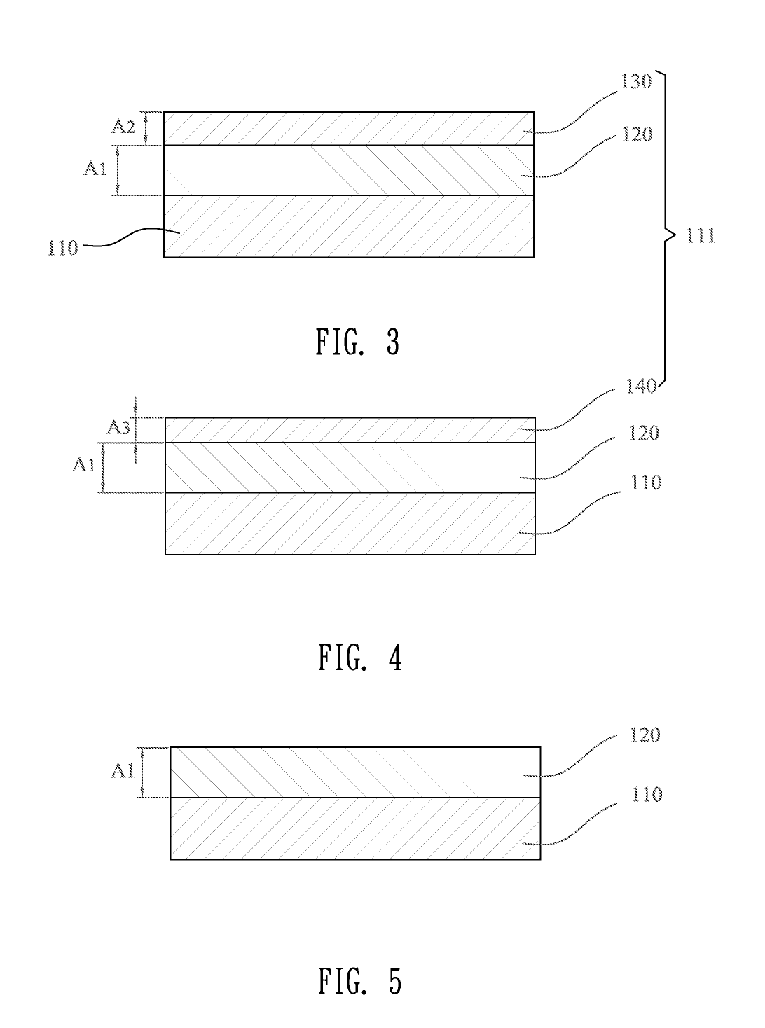

Referring to FIG. 1-FIG. 5, a contact 10 of an electrical connector in accordance with the present invention is generally of a multi-layer structure. The multi-layer structure generally includes a base layer 110 and a plating layer 111 plated on the base layer 110. The base layer 110 includes a contacting portion D1 at one end thereof, a soldering portion D2 at the other end thereof and a connecting portion D3 connecting the contacting portion D1 and the soldering portion D2. The base layer 110 is stamped from a metal plate and is of a curved slice shape. The base layer 110 can be stamped from brass, bronze, phosphor copper, other aluminum alloy or other metal alloy. The plating layer 111 can be formed by a layer of metal (such as nickel, gold or stannum) in order to have a better electric conductive performance or a better soldering performance. The contacting portion D1, the soldering portion D2 and the connecting portion D3 of the base layer 110 are all plated by a nickel plating layer 120. A first gold plating layer 130 is plated on a portion of the nickel plating layer 120 corresponding to the contacting portion D1. A proper thickness A1 of the nickel plating layer 120 is 2 um. A proper thickness A2 of the first gold plating layer 130 is 0.3 um. A second gold plating layer 140 is plated on a portion of the nickel plating layer 120 corresponding to the soldering portion D2. A proper thickness A3 of the second gold plating layer 140 is 0.05 um. The nickel plating layer 120, the first gold plating layer 130 and the second gold plating layer 140 together define the plating layer 111. The contacting portion D1 is used for connecting with a mated electronic part (not shown). The soldering portion D2 is used for soldering the contact 10 to a printed circuit board (not shown). The contacting portion D1 and the soldering portion D2 are plated by the nickel plating layer 120, and then are plated by the first and second gold plating layers 130,140, respectively to realize a good electric conductivity and improve oxidation resistance. The thickness A2 of the first gold plating layer 130 of the contacting portion D1 is thicker than the thickness A3 of the second gold plating layer 140 of the soldering portion D2 so as to prevent the contacting portion D1 from being worn to lose or lower electric conductivity performance by means of contacting with the electronic parts time after time.

Referring to FIG. 1-FIG. 5 again, a top of the contacting portion D1 of the base layer 110 is protruded upward to form a protrusion 150. The protrusion 150 can provide a good electrical connection between the contact 10 and the mated electronic part. No gold plating layer is plated on a middle portion of the nickel plating layer 120 corresponding to the connecting portion D3 in this embodiment. The nickel plating layer 120 is kept as a top layer of the connecting portion D3. So that an exposed area of nickel is formed, and effectively restrain a phenomenon of solder climbing during the soldering portion D2 of the contact 10 being soldered to the printed circuit board.

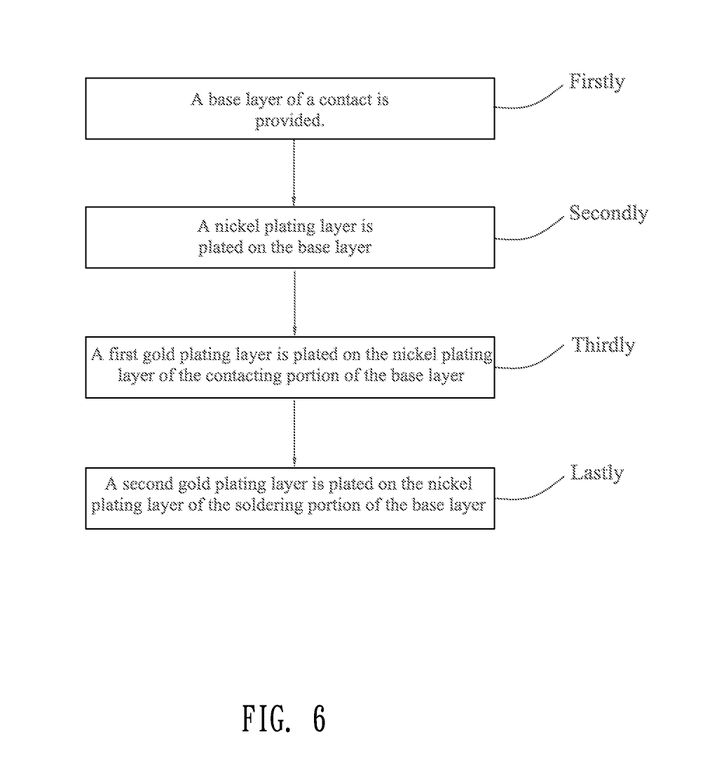

Referring to FIGS. 1-6, FIG. 6 is a flow chart of the contact 10 plating method of the invention. Steps of the contact 10 plating method of this invention are as following. Firstly, provide the base layer 110 which is of a curved slice structure and is stamped from the metal plate. Secondly, an immersion plating method can be used for plating the nickel plating layer 120 on the base layer 110. Thirdly, a brush plating method can be used for plating the first gold layer 130 on the portion of the nickel plating layer 120 corresponding to the contacting portion D1. Lastly, the brush plating method can be used for plating the second gold layer 140 on the portion of the nickel plating layer 120 corresponding to the soldering portion D2. After finishing plating the first and second gold plating layers 130, 140 on the portions of the nickel plating layer 120 corresponding to the contacting portion D1 and the soldering portion D2, the middle portion of the nickel plating layer 120 corresponding to the connecting portion D3 is still exposed outside.

The first gold plating layer 130 plated on the portion of the nickel plating layer 120 corresponding to the contacting portion D1 and the second gold plating layer 140 plated on the portion of the nickel plating layer 120 corresponding to the soldering portion D2 can be formed not only by means of the brush plating method, but also by means of the immersion plating method. Sequences of the third step and the last step described above can be exchanged.

As described above, after the contacting portion D1, the soldering portion D2 and the connecting portion D3 of the base layer 110 is plated by the nickel plating layer 120, the first and second gold plating layers 130, 140 are plated on two end portions of the nickel plating layer 120 corresponding to the contacting portion D1 and the soldering portion D2, respectively, the middle portion of the nickel plating layer 120 corresponding to the connecting portion D3 is exposed outside to form an exposed area of nickel. So that the electric conductivity performance of the contact 10 can be guaranteed and the phenomenon of solder climbing is effectively restrained in a process of soldering the soldering portion D2 of the contact 10 to the printed circuit board. As a result, a better electric conductivity performance is realized.

What is claimed is:

1. A contact included by an electrical connector, comprising:
a base layer including a contacting portion at one end thereof, a soldering portion at the other end thereof, and a connecting portion connecting the contacting portion and the soldering portion; and
a plating layer plated on the base layer, the plating layer comprising a nickel plating layer plated on the contacting portion, the soldering portion and the connecting portion of the base layer, a first gold plating layer and a second gold plating layer plated on two end portions of the nickel plating layer corresponding to the contacting portion and the soldering portion, respectively, a middle portion of the nickel plating layer corresponding to the connecting portion being exposed outside.

2. The contact as claimed in claim 1, wherein the base layer is stamped from brass, bronze, phosphor copper, other aluminum alloy or other metal alloy.

3. The contact as claimed in claim 1, wherein a top of the contacting portion of the base layer is protruded upward to form a protrusion for providing a good electrical connection between the contact and a mated electronic part.

4. The contact as claimed in claim 1, wherein thickness of the first gold plating layer is thicker than that of the second gold plating layer.

5. A contact plating method, comprising steps of:
providing a base layer of the contact which includes a contacting portion, a soldering portion and a connecting portion connecting the contacting portion and the soldering portion;
plating a nickel plating layer on the contacting portion, the soldering portion and the connecting portion of the base layer;
plating a first gold plating layer on a portion of the nickel plating layer corresponding to the contacting portion; and
plating a second gold plating layer on a portion of the nickel plating layer corresponding to the soldering portion, with a portion of the nickel plating layer corresponding to the connecting portion exposed outside.

6. The plating method as claimed in claim 5, wherein the nickel plating layer is plated on the base layer by means of an immersion plating method.

7. The plating method as claimed in claim 5, wherein the first gold plating layer is plated on the portion of the nickel plating layer corresponding to the contacting portion by means of a brush plating method or an immersion plating method.

8. The plating method as claimed in claim 5, wherein the second gold plating layer is plated on the portion of the nickel plating layer corresponding to the soldering portion by means of a brush plating method or an immersion plating method.

9. The plating method as claimed in claim 5, wherein sequences of step three and step four described above can be exchanged.
